(19) United States
(12) Patent Application Publication
(10) Pub. No.: US 2007/0211338 A1
(43) Pub. Date: Sep. 13, 2007

(54) Polarization conversion element and method for manufacturing polarization conversion element

(75) Inventor: Daiki Furusato, Minowa-machi (JP)

Correspondence Address: OLIFF & BERRIDGE, PLC, P.O. BOX 19928, ALEXANDRIA, VA, 22320, US

(73) Assignee: EPSON TOYOCOM CORPORATION, TOKYO (JP)

(21) Appl. No.: 11/713,741

(22) Filed: Mar. 5, 2007

(30) Foreign Application Priority Data
Mar. 13, 2006 (JP) 2006-067573
Feb. 13, 2007 (JP) 2007-031609

(51) Int. Cl. G02B 27/28

(52) U.S. Cl. 359/495; 359/483

(57) ABSTRACT

A polarization conversion element includes: a first transparent member, having: a light incident surface; a light exit surface almost parallel to the light incident surface; a first coating-forming surface formed to have a predetermined angle with the light incident surface and the light exit surface; a second coating-forming surface formed to have a predetermined angle with the light incident surface and the light exit surface, the second coating-forming surface being almost parallel to the first coating-forming surface; a polarization separation coating formed on the first coating-forming surface; and a reflective coating formed on the second coating-forming surface; a plurality of second transparent members, having: a light incident surface formed on a same plane on which the light incident surface of the first transparent member is formed; and a light exit surface formed on a same plane on which the light exit surface of the first transparent member is formed, the plurality of second transparent members being alternately joined with the first transparent member; and a polarization conversion member converting polarized light arranged in one of a light path for polarized light transmitting the polarization separation coating and a light path for polarized light reflected by the reflective coating; wherein the polarization separation coating includes a first polarization separation coating layer and a second polarization separation coating layer, the first polarization separation coating layer being formed with a first low refractive index coating made of a first low refractive index material having compressive stress and a high refractive index coating made of a high refractive index material alternately laminated, the second polarization separation coating layer being formed with a second low refractive index coating made of a second low refractive index material having tensile stress and the high refractive index coating alternately laminated.

### BACKGROUND

1. Technical Field

The present invention relates to a polarization conversion element that converts natural light from a light source used in a liquid crystal projector or the like into linearly polarized light, and a method for manufacturing the same.

2. Related Art

FIG. 5 shows a structure of a polarization conversion element of related art. A polarization conversion element 100 in FIG. 5 is formed with a plurality of prisms 101 and 102 each having a cross-section in a parallelogram bonded each other on their sides with an optical adhesive. A side of the prism 102 has a polarization separation coating 110 formed thereon while a side of the prism 101 has a reflective coating 120 formed thereon. The prisms 101 and 102 are alternately bonded on their sides each other as above, thereby arranging the polarization separation coating 110 and the reflective coating 120 alternately. Further, in order to obtain a single type of linearly polarized light, a light exit surface 101a of linearly polarized light, which is a side of the prism 101, is bonded with a half-wave plate 103, forming the polarization conversion element 100.

As for a document for related art, JP-A-2000-143264 discloses a technique related to a method for manufacturing an optical device being mirror-polished without a troublesome mirror-polishing process after being divided. Further, Japanese Patent No. 3486516 discloses an optical element improving an efficiency to use light.

Furthermore, JP-A-2005-43755 discloses an optical multilayer filter that can prevent an optical distortion by reducing an amount of warpage of a substrate caused by stress from a coating of a dielectric laminated on a transparent substrate and a method for manufacturing the optical multilayer filter while JP-A-7-209516 discloses a multilayer filter that can reduce stress and warpage to a coating compared to an optical multilayer filter of related art even if the number of dielectric multilayer coatings is increased to 40 layers or more.

The polarization separation coating 110 of the polarization conversion element 100 described above is formed with a lanthanum aluminate coating 111 and a MgF₂ coating 112 alternately laminated more than once on a glass board 113 serving as a glass prism 102 as shown in FIG. 6. The lanthanum aluminate coating 111 is a material having a high refractive index made of a composite oxide of lanthanum (La) and aluminum (Al) while the MgF₂ coating 112 is a material having a low refractive index.

However, the polarization conversion element 100 of related art described above has a problem such as detachment of the polarization separation coating on the boundary surface between the glass prism 102 and the polarization separation coating 110 as shown in FIG. 7, or degradation of an optical characteristic caused by cracks in the polarization separation coating.

As a result of dedicated investigations to identify causes of the aforementioned problems, the inventor of the invention found out that the problems were caused by coating stress of the MgF₂ coating 112.

FIG. 8 shows an action of coating stress of the polarization separation coating 110 mentioned above.

In FIG. 8, F1 indicates a tensile force or compressive force to the coating by an elasticity modulus of the glass board 113 serving as the glass prism 102. F1 is inherent in a glass material such as the glass board 113. Hereinafter, F1 is called as glass elasticity.

Further, F2 indicates coating stress of the lanthanum aluminate coating 111, and F3 indicates coating stress of the MgF₂ coating 112 while F0 indicates integrated stress. A direction and a magnitude of coating stress are greatly affected by conditions of a vapor deposition. Therefore, directions and magnitudes of the coating stress F2 and F3 here are obtained by actually forming the lanthanum aluminate coating 111 and the MgF₂ coating. As for the coating forming method, an electron beam (hereinafter, referred to as EB) deposition, sputtering, assist coating forming such as ion plating and an ion assist method are cited. The method can be appropriately selected among them by a designer based on a specification or the like for a polarization separation element.

A feature of the ion assist method is that ions of a material to be deposited are accelerated to be deposited on a surface of a glass board, thereby improving adhesiveness of a coating material with the glass board.

Here, the coating stress F2 of the lanthanum aluminate coating 111 acts in a tensile direction against the glass board 113 and the coating stress F3 of the MgF₂ coating 112 also acts in the tensile direction against the glass board 113. Further, when magnitudes of the coating stress F2 and the coating stress F3 are compared, for example, the coating stress F2 for the lanthanum aluminate coating 111 is about 0.15 GPa while the coating stress F3 for the MgF₂ coating 112 is about 0.31 GPa. Therefore, the coating stress in total acts about 0.46 GPa against the glass board 113 in the tensile direction. As a result, even if the glass elasticity F1 of the glass board 113 is added, the total stress F0 of the coatings acts in the tensile direction against the glass board 113, thereby causing detachment of the polarization separation coating 110 and cracks in a boundary surface between the glass board 113 and the polarization separation coating 110.

### SUMMARY

An advantage of the invention is to provide a polarization conversion element and a method for manufacturing the polarization conversion element without causing detachment of a polarization separation coating on a boundary surface with a glass board and occurrence of cracks.

A polarization conversion element includes: a first transparent member, having: a light incident surface; a light exit surface almost parallel to the light incident surface; a first coating-forming surface formed to have a predetermined angle with the light incident surface and the light exit surface; a second coating-forming surface formed to have a predetermined angle with the light incident surface and the light exit surface, the second coating-forming surface being almost parallel to the first coating-forming surface; a polarization separation coating formed on the first coating-forming surface; and a reflective coating formed on the second coating-forming surface; a plurality of second transparent members, having: a light incident surface formed on a same plane on which the light incident surface of the first transparent member is formed; and a light exit surface formed on a same plane on which the light exit surface of the first transparent member is formed, the plurality of second transparent members being alternately joined with the first transparent member; and a polarization conversion member converting polarized light arranged in one of a light path for polarized light transmitting the polarization separation coating and a light path for polarized light reflected by the reflective coating; wherein the polarization separation coating includes a first polarization separation coating layer and a second polarization separation coating layer, the first polarization separation coating layer being formed with a first low refractive index coating made of a first low refractive index material having compressive stress and a high refractive index coating made of a high refractive index material alternately laminated, the second polarization separation coating layer being formed with a second low refractive index coating made of a second low refractive index material having tensile stress and the high refractive index coating alternately laminated.

According to an aspect of the invention, the polarization separation coating is formed with the first polarization separation coating layer and the second polarization separation coating layer, the first polarization separation coating layer being formed with the first low refractive index coating having compressive stress and the high refractive index coating alternately laminated, the second polarization separation coating layer being formed with the second low refractive index coating having tensile stress and the high refractive index coating alternately laminated. Therefore, coating stress of the first polarization separation coating layer acting in a tensile direction against the first transparent member is balanced out with coating stress of the second polarization separation coating layer acting in a compressive direction toward the first transparent member, preventing the polarization separation coating from detaching on the boundary surface between the first transparent member and the polarization separation coating, and cracks from occurring. Degradation of optical characteristics of the polarization conversion element is thus prevented.

Further, if the first low refractive index coating is formed with a SiO₂ coating while the second low refractive index coating is formed with a MgF₂ coating, tensile stress of the MgF₂ coating is balanced out with compressive stress of the SiO₂ coating. As a result, detachment of the polarization separation coating on the boundary surface between the first transparent member and the polarization separation coating, and cracks in the polarization separation coating are prevented. It is thus ensured to prevent degradation of optical characteristics of the polarization conversion element.

Furthermore, a method for manufacturing the polarization conversion element includes preparing a first transparent board being a parallel plate and a second transparent board being a parallel plate, forming the polarization separation coating on a first main surface of the first transparent board and the reflective coating on a second main surface of the first transparent board, forming a layered body by alternately laminating the first transparent board and the second transparent board with an adhesive so that a plane connecting edges of the first transparent board and the second transparent board makes an inclination angle of about 45 degrees to the first transparent board and the second transparent board by being sequentially shifted in a surface direction of the first transparent board and the second transparent board to be in a staircase pattern, a first cutting to cut the layered body being integrated at cutting planes parallel to each other and arranged by a predetermined pitch along an inclination angle of 45 degrees to provide a plurality of layered segments, and attaching a half-wave plate to selected portions of each exit surface of the plurality of layered segments. Accordingly, the method for manufacturing the polarization conversion element as above does not cause detachment of the polarization separation coating on a boundary surface with the glass board and occurrence of cracks, thereby improving a yield of the polarization conversion element.

### BRIEF DESCRIPTION OF THE DRAWINGS

The invention will be described with reference to the accompanying drawings, wherein like numbers reference like elements.

FIG. 1 is a diagram showing a structure of a polarization conversion element according to an embodiment.

FIG. 2 is a diagram schematically showing a structure of a polarization separation coating of the polarization conversion element according to the embodiment.

FIG. 3 shows an action of coating stress of the polarization conversion element according to the embodiment.

FIGS. 4A through 4D are process charts for explaining a method for manufacturing the polarization conversion element according to the embodiment.

FIG. 5 is a diagram for explaining a structure of a polarization conversion element and a method for using the polarization conversion element according to related art.

FIG. 6 is a diagram schematically showing a structure of a polarization separation coating of the polarization conversion element shown in FIG. 5.

FIG. 7 is a diagram for explaining problems of the polarization conversion element according to related art.

FIG. 8 shows an action of coating stress of the polarization separation coating according to related art.

### DESCRIPTION OF EXEMPLARY EMBODIMENTS

Embodiments of the present invention will now be described in detail with reference to the accompanying drawings.

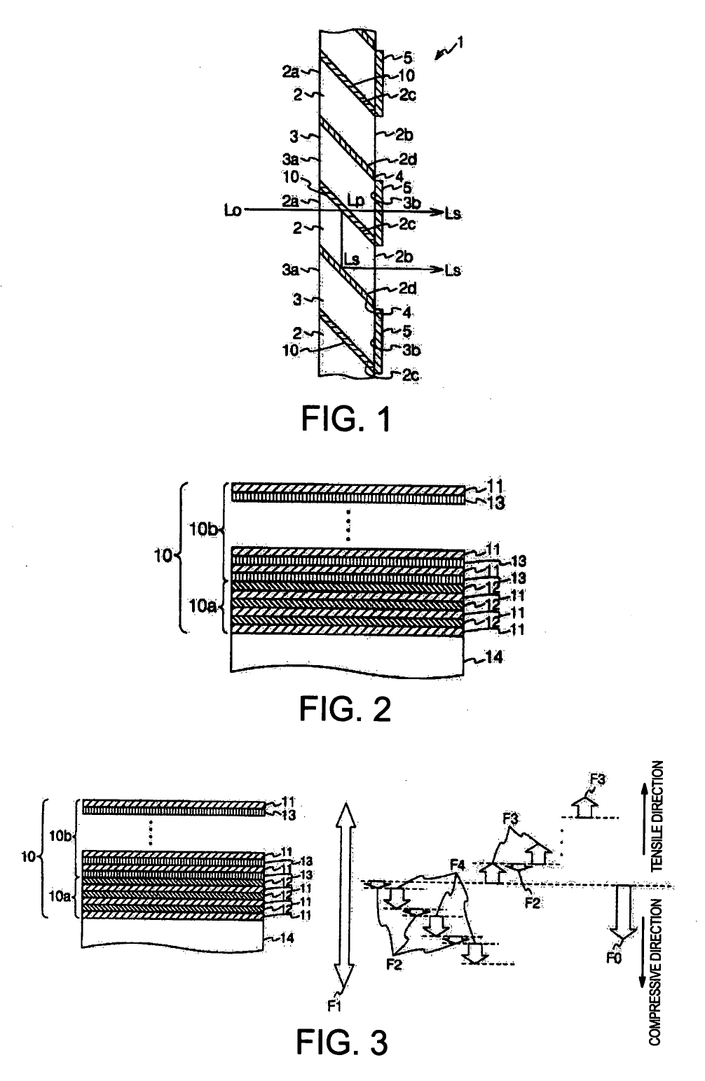

FIG. 1 is a diagram showing a structure of a polarization conversion element according to an embodiment.

A polarization conversion element 1 according to the embodiment as shown in FIG. 1 is formed with a first transparent member 2 and a second transparent member 3 alternately joined each other. The first transparent member 2 includes a light incident surface 2a and a light exit surface 2b nearly parallel to the light incident surface 2a, and further includes a first coating-forming surface 2c and a second coating-forming surface 2d parallel to each other and formed to have a predetermined angle (45 degrees, for example) to the light incident surface 2a and the light exit surface 2b. The first coating-forming surface 2c has a polarization separation coating 10 formed while the second coating-forming surface 2d has a reflective coating 4 formed.

Further, the second transparent member 3 is provided with a light incident surface 3a and a light exit surface 3b that are respectively formed on the same plane as the light incident surface 2a and the light exit surface 2b of the first transparent member 2.

On the exit surface 3b of the second transparent member 3, a half-wave plate 5 is formed as a polarization conversion member. In this embodiment, the half-wave plate 5 is formed in a light path of polarization light transmitted through the polarization separation coating 10. However, the half-wave plate 5 can be formed in a light path of polarization light reflected by the reflective coating 4, that is, on the exit surface 2b of the first transparent member 2.

The first transparent member 2 and the second transparent member 3 are made of a sheet of glass. However, it is possible to use a sheet of a transparent member other than glass. The polarization separation coating 10 has a property that selectively transmits one of S polarization light and P polarization light and selectively reflects the other one. Details about the polarization separation coating 10 will be described later.

The reflective coating 4 is preferably made of a dielectric multilayer coating that reflects a linearly polarized component (S polarization light or P polarization light) reflected by the polarization separation coating 10. The reflective coating 4 can be formed by vapor deposition of aluminum.

If the reflective coating 4 is formed by a dielectric multilayer, it can reflect a specific linearly polarized component such as S polarization light at a reflectance of about 98%. On the other hand, a reflectance of an aluminum coating is about 92% at most. Therefore, forming the reflective coating 4 with a dielectric multilayer can increase a light amount output from the polarization conversion element 1. In addition, the dielectric multilayer has an advantage such as low heat generation because its light absorption is smaller than that of an aluminum coating. To improve a reflectance of the specific linearly polarized component, a coating thickness or a material of each coating forming the dielectric multilayer (normally two types of coatings laminated alternately) forming the reflective coating 4 can be optimized.

Further, the polarization conversion element 1 structured as above according to the embodiment includes the polarization separation coating 10 formed as below.

FIG. 2 is a diagram schematically showing a structure of the polarization separation coating 10 for the polarization conversion element 1 according to the embodiment.

As shown in FIG. 2, the polarization separation coating 10 of the polarization conversion element 1 according to the embodiment is provided with a first polarization separation coating layer 10a made of a lanthanum titanate coating (high refractive index coating) 11 and a silicon dioxide (SiO₂) coating 12 (first low refractive index coating) alternately layered more than once on a glass board 14. The lanthanum titanate coating 11 is made of a composite oxide of lanthanum (La) and titanium (Ti) that are high refractive index materials while the SiO₂ coating is made of SiO₂. Further, the polarization separation coating 10 is provided with a second polarization separation coating layer 10b made of a magnesium fluoride (MgF₂) coating (second low refractive index coating) 13 and the lanthanum titanate coating (high refractive index coating) 11 alternately laminated more than once. The MgF₂ coating 13 is made of MgF₂ that is a second low refractive index material.

In this embodiment, a lanthanum titanate coating is exemplified as the high refractive index coating 11 to explain. However, it is possible to use a variety of high refractive index coatings such as a lanthanum aluminate coating is made of a composite oxide of La and aluminum (Al). And SiO₂ coating is exemplified as the first law refractive index coating 12 to explain. However, it is possible to use a variety of law refractive index coatings such as Ta₂O₅ coatings, TiO₂ coatings, Nb₂O₅ coating and Al₂O₃ coatings.

FIG. 3 shows an action of coating stress of the polarization separation coating 10.

In FIG. 3, F1 indicates glass elasticity of the glass board 14 serving as the first transparent member 2. F2 indicates coating stress of the lanthanum titanate coating 11 while F3 indicates coating stress of the MgF₂ coating 13. Further, F4 indicates coating stress of the SiO₂ coating 12 while F0 indicates total stress. A direction and a magnitude of coating stress are greatly affected by conditions of a vapor deposition. Therefore, directions and magnitudes for coating stress F2, F3, and F4 are obtained by actually forming the lanthanum titanate coating 11, the SiO₂ coating 12, and the MgF₂ coating 13 on the glass board 14 with EB coating forming, sputtering, assist coating forming or the like. In this case, the coating stress F2 of the lanthanum titanate coating 11 and the coating stress F4 of the SiO₂ coating 12 act in a compressive direction toward the glass board 14 while the coating stress F3 of the MgF₂ coating 13 acts in a tensile direction against the glass board 14.

When a magnitude of the coating stress F2 is compared to that of the coating stress F4, for example, the coating stress F2 of the lanthanum titanate coating 11 is 0.05 GPa while the coating stress F4 of the SiO₂ coating 12 is 0.3 GPa. In addition, the coating stress F3 of the MgF₂ coating 13 is 0.31 GPa. Therefore, when the coating stress F2, F3, and F4 is compared, the coating stress F3 of the MgF₂ coating 13 and the coating stress F4 of the SiO₂ coating 12 are almost same while the coating stress F2 of the lanthanum titanate coating 11 is small enough to be ignored compared to the coating stress F3 of the MgF₂ coating 13 and the coating stress F4 of the SiO₂ coating 12.

In this embodiment, the first polarization separation coating layer 10a made of the SiO₂ coating 12 having compressive stress toward the glass board 14 and the lanthanum titanate coating 11 is formed with the second polarization separation coating layer 10b made of the MgF₂ coating 13 having tensile stress against the glass substrate 14 and lanthanum titanate coating 11, thereby the coating stress F3 of the MgF₂ coating 13 acting in the tensile direction is balanced out with the coating stress F4 of the SiO₂ coating 12 acting in the compressive direction. Therefore, the number of layers of the SiO₂ coating 12 is set to be almost the same as that of the MgF₂ coating 13, or the number of layers of the MgF₂ coating 13 is set to be more than that of the SiO₂ coating 12.

Accordingly, the total stress F0 of the polarization separation coating 10 of the embodiment is in balance, or can act in the compressive direction against the glass board 14, thereby preventing the polarization separation coating 10 from detaching on the boundary surface between the glass board 14 and the polarization separation coating 10 and cracks from occurring.

The number of layers of the MgF₂ coating 13 for the second polarization separation coating layer 10b and the number of layers of the SiO₂ coating 12 for the first polarization separation coating layer 10a can be appropriately determined in consideration of optical characteristics required, coating stress of the MgF₂ coating 13 and the SiO₂ coating 12, and glass elasticity of the glass board 14 serving as the first transparent member 2 and the like.

Further, as for a sequence for the first polarization separation coating layer 10a and the second polarization separation coating layer 10bto form the polarization separation coating 10, it is preferable that the first polarization separation coating layer 10a made of a material having compressive stress be formed on the side adjacent to the glass board 14 in order to ensure adherence on the boundary surface between the glass board 14 and the polarization separation coating layer.

Next, a method for manufacturing the polarization conversion element is described.

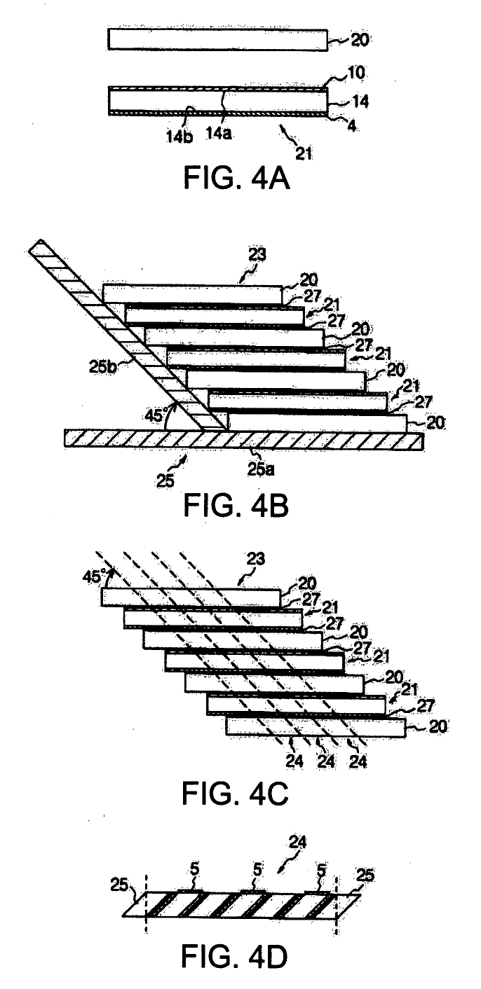

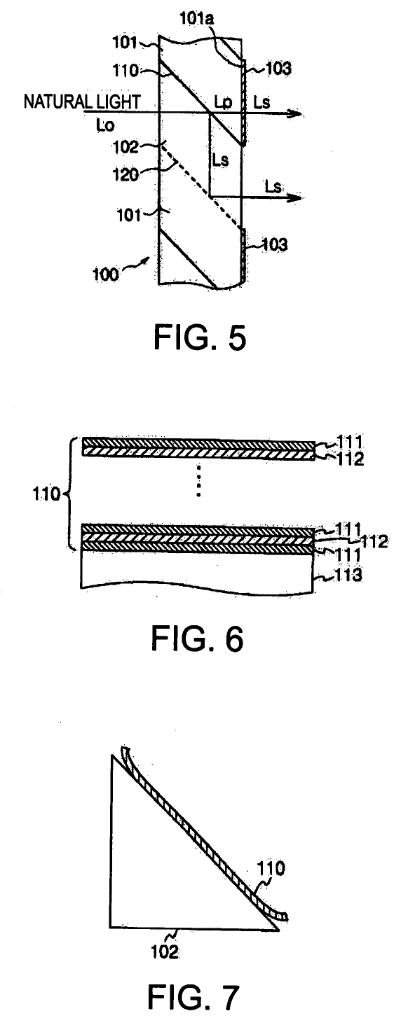

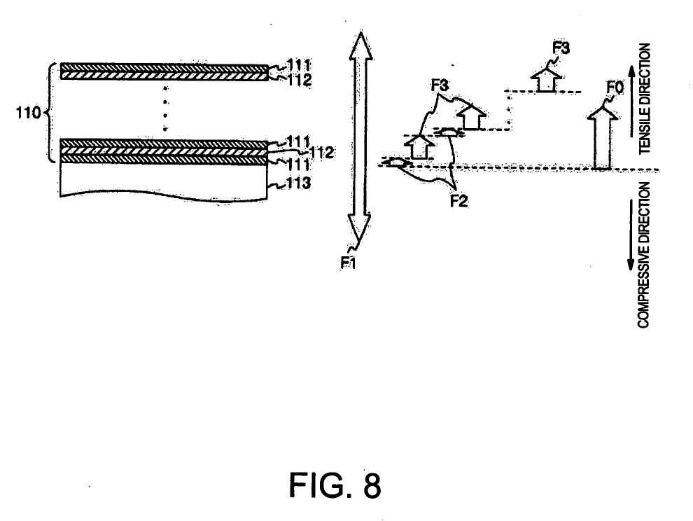

FIGS. 4A through 4D show the method for manufacturing the polarization conversion element according to the embodiment.

In this embodiment, as a preparation step, a glass board (first transparent board) 20 having both upper and lower surfaces mirror-finished, and the glass board 14 also having both upper and lower surfaces mirror-finished are prepared. Then, as a coating-forming step shown in FIG. 4A, the polarization separation coating 10 is formed on a first main surface 14a of the glass board 14, and the reflective coating 4 is formed on a second main surface 14b so as to form a second transparent board 21. The polarization separation coating 10 is formed with an ion assist method in the embodiment. That is, the lanthanum titanate coating (high refractive index coating) 11 made of a high refractive index material and the SiO₂ coating (first low refractive index coating) 12 made of SiO₂ are alternately layered more than once on the glass board 14, forming the first polarization separation coating layer 10a. Concurrently, the MgF₂ coating (second low refractive index coating) 13 made of MgF₂ that is a second low refractive index material and the lanthanum titanate coating (high refractive index coating) 11 are alternately layered more than once, forming the second polarization separation coating layer 10b.

Next, the first transparent board 20 and the second transparent board 21 are alternately layered using a jig 25 shown in FIG. 4B in a layered body forming step, forming a layered body 23. The jig 25 includes a base 25a and an inclined sidewall 25b. The base 25a is a horizontal board and the inclined sidewall 25b is fixed to the base 25a to be inclined at an inclination angle of 45 degrees upwards from the base 25a. The first transparent board 20 and the second transparent board 21 are laminated so that a plane connecting edges of the first transparent board 20 and the second transparent board 21 to be laminated makes an inclination angle of about 45 degrees to the first transparent board 20 and the second transparent board 21 by being sequentially shifted at an equal distance in a surface direction to form the layered body 23 in a staircase pattern.

Before the first transparent board 20 and the second transparent board 21 are layered, an ultraviolet (UV) cure adhesive 27 is applied therebetween. Then the layered body 23 is pressed so as to spread the UV cure adhesive 27 evenly, followed by radiation of ultraviolet to the layered body 23 with an ultraviolet ray irradiation device, which is not shown, so that the boards forming the layered body 23 are joined by curing the UV cure adhesive.

Subsequently, as a first cutting step, the layered body 23 integrated as above is removed from the jig 25 and provisionally fixed to a fixing board that is not shown at a sidewall on a rear side of the layered body 23 with a removable adhesive or the like. Then, the layered body 23 provisionally fixed is cut along cutting lines in about 45 degrees as indicated dotted lines shown in FIG. 4C. That is, the layered body 23 is cut with a wire saw at cutting planes parallel to each other and arranged by a predetermined pitch in even intervals along an inclination angle of 45 degrees, providing a plurality of layered segments 24.

Then, as a second cutting step, protrusions 25 that are protruded at an acute angle from both ends of each of the layered segments 24 cut as shown in FIG. 4D are cut. Thereafter, as an attaching step, a half-wave plate is attached to a part of each of the layered segments 24, improving a yield of the polarization conversion element 1.

What is claimed is:

1. A polarization conversion element, comprising:
a first transparent member, including:
a light incident surface;
a light exit surface almost parallel to the light incident surface;
a first coating-forming surface having a predetermined angle with the light incident surface and the light exit surface;
a second coating-forming surface having a predetermined angle with the light incident surface and the light exit surface, the second coating-forming surface being almost parallel to the first coating-forming surface;
a polarization separation coating formed on the first coating-forming surface; and
a reflective coating formed on the second coating-forming surface;
a plurality of second transparent members, including:
a light incident surface formed on a same plane on which the light incident surface of the first transparent member is formed; and
a light exit surface formed on a same plane on which the light exit surface of the first transparent member is formed, the plurality of second transparent members being alternately joined with the first transparent member; and
a polarization conversion member converting polarized light arranged in one of a light path for polarized light transmitting the polarization separation coating and a light path for polarized light reflected by the reflective coating;
wherein the polarization separation coating includes a first polarization separation coating layer and a second polarization separation coating layer, the first polarization separation coating layer being formed with a first low refractive index coating made of a first low refractive index material having compressive stress and a high refractive index coating made of a high refractive index material alternately laminated, the second polarization separation coating layer being formed with a second low refractive index coating made of a second low refractive index material having tensile stress and the high refractive index coating alternately laminated.

2. The polarization conversion element according to claim 1, wherein the first low refractive index coating is a SiO₂ coating while the second low refractive index coating is a MgF₂ coating.

3. A method for manufacturing the polarization conversion element according to claim 1, comprising:
preparing a first transparent board being a parallel plate and a second transparent board being a parallel plate;
forming the polarization separation coating on a first main surface of the first transparent board and the reflective coating on a second main surface of the first transparent board;
forming a layered body by alternately laminating the first transparent board and the second transparent board with an adhesive so that a plane connecting edges of the first transparent board and the second transparent board makes an inclination angle of about 45 degrees to the first transparent board and the second transparent board by being sequentially shifted in a surface direction of the first transparent board and the second transparent board to be in a staircase pattern;
a first cutting to cut the layered body being integrated at cutting planes parallel to each other and arranged by a predetermined pitch along an inclination angle of 45 degrees to provide a plurality of layered segments;
attaching a half-wave plate to selected portions of each exit surface of the plurality of layered segments.
